(19) United States
(12) Patent Application Publication
(10) Pub. No.: US 2004/0096026 A1
(43) Pub. Date: May 20, 2004

(54) Apparatus and methods for optimizing reactor core coolant flow distributions

(76) Inventors: Hwang Choe, Saratoga, CA (US); Jose L. Casillas, Cupertino, CA (US); Sig Wolf, Sunnyvale, CA (US); Mark Joseph Colby, Wilmington, NC (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/065,772

(22) Filed: Nov. 18, 2002

(51) Int. Cl. G21C 19/28; G21C 15/00

(52) U.S. Cl. 376/373

(57) ABSTRACT

A nuclear reactor core is provided that includes a plurality of fuel assemblies. In an exemplary embodiment, each fuel assembly includes a main coolant flow channel having an inlet. The plurality of fuel assemblies are arranged into at least three regions within the core. The flow channels are configured so that the flow of coolant through the main coolant flow channels of the fuel assemblies located in a particular region are substantially the same, and that the coolant flow through the fuel assemblies in each region is different from the coolant flow through the fuel assemblies in each other region.

### BACKGROUND OF INVENTION

This invention relates generally to nuclear reactors, and more particularly to optimizing reactor core coolant flow distributions.

A known reactor pressure vessel (RPV) of a boiling water reactor (BWR) has a generally cylindrical shape and is closed at both ends, e.g., by a bottom head and a removable top head. A top guide is spaced above a core plate within the RPV. A core shroud, or shroud, surrounds the core plate and is supported by a shroud support structure. Particularly, the shroud has a generally cylindrical shape and surrounds both the core plate and the top guide. The top guide includes several openings, and fuel bundles are inserted through the openings and are supported by the core plate. The core plate includes a flat plate supported by a plurality of beams.

A nuclear reactor core includes individual fuel assemblies that have different characteristics that affect the strategy for operation of the core. For example, a nuclear reactor core has many, e.g., several hundred, individual fuel bundles that have different characteristics. Such bundles are arranged within the reactor core so that the interaction between the fuel bundles satisfies all regulatory and reactor design constraints, including governmental and customer specified constraints. In addition to satisfying the design constraints, since the core loading arrangement determines the cycle energy, i.e., the amount of energy that the reactor core generates before the core needs to be refreshed with new fuel elements, the core loading arrangement preferably optimizes the core cycle energy.

In order to furnish the required energy output, the reactor core is periodically refueled with fresh fuel bundles. To optimize core cycle energy, the higher reactivity bundles may be positioned at an inner core location. To satisfy some design constraints, however, higher reactivity bundles generally are positioned some distance from the center of the core, but not adjacent the periphery of the core. The most depleted fuel bundles, i.e., the bundles with the least remaining energy content, are removed from the reactor. The interval between refuelings is referred to as a cycle of operation.

During the course of the cycle of operation, the excess reactivity, which defines the energy capability of the core, is controlled in two ways. Specifically, a burnable poison, e.g., gadolinia, is incorporated in the fresh fuel. The quantity of initial burnable poison is determined by design constraints typically set by the utility and by the NRC. The burnable poison controls most, but not all, of the excess reactivity.

Control rods also control the excess reactivity. Specifically, the reactor core contains control rods which assure safe shutdown and provide the primary mechanism for controlling the maximum power peaking factor. The total number of control rods available varies with core size and geometry, and is typically between 50 and 269. The position of the control rods, i.e., fully inserted, fully withdrawn, or somewhere between, is based on the need to control the excess reactivity and to meet other operational constraints, such as the maximum core power peaking factor.

Normal coolant flow entering the fuel assemblies is single phased and slightly subcooled. The flow approaches the fuel support vertically upward and then turns horizontally as the flow enters the inlet to the fuel support. The flow then passes through an orifice that provides a pressure drop to assist coolant distribution to the fuel bundles. The flow then turns vertical again and enters the lower tie plate of the fuel assembly, being distributed around the individual fuel pins.

Known BWRs include two orifice regions usually designated as peripheral and center. The peripheral region includes all fuel locations around the periphery of the core, and the center region includes the remainder of the locations. The inlet orifice design limits the peripheral region flow per fuel element to about half of the flow per fuel element of the center region. Limiting the peripheral flow by this magnitude permits the very low power peripheral fuel elements to saturate the coolant flow, but the exit quality and average voids are still much lower than for the other higher power region. This uneven exit quality and average void can produce inefficient steam separation and nuclear moderation.

### SUMMARY OF INVENTION

In one aspect, a nuclear reactor core is provided that includes a plurality of fuel assemblies. Each fuel assembly includes a main coolant flow channel having an inlet. The plurality of fuel assemblies are arranged into at least three regions within the core. The flow channels are configured so that the flow of coolant through the main coolant flow channels of the fuel assemblies located in a particular region are substantially the same, and that the coolant flow through the fuel assemblies in each region is different from the coolant flow through the fuel assemblies in each other region.

In another aspect, a nuclear reactor core is provided that includes a plurality of fuel assemblies and a plurality of coolant orifices. Each fuel assembly includes a main coolant flow channel having an inlet and each coolant orifice is located in an inlet of a cooling flow channel. The plurality of fuel assemblies are arranged into at least three regions within the core. The coolant orifices are sized so that the flow of coolant through the main coolant flow channels of the fuel assemblies located in a particular region are substantially the same, and that the coolant flow through fuel assemblies in each region is different from the coolant flow through the fuel assemblies in each other region.

In another aspect, a nuclear reactor core is provided that includes a plurality of fuel assemblies. Each fuel assembly includes a lower tie plate and a main coolant flow channel comprising an inlet. The reactor core further includes at least one of a plurality of coolant orifices and a plurality of flow restriction devices. Each coolant orifice includes a diameter and is located in an inlet of a cooling flow channel. Each restriction device is detachably coupled to a lower end of the lower tie plate. The plurality of fuel assemblies are arranged into at least three regions within the core. The diameter of the coolant orifices located in a particular region are substantially the same, and the diameter of the coolant orifices of each region is different from said diameter of the coolant orifices in each other region. The flow restriction devices located in a particular region are sized to be the same, and the size of the flow restriction devices of each region is different from the size of the flow restriction devices of each other region.

In another aspect, a method for optimizing reactor core coolant flow distributions is provided. The reactor core includes a plurality of fuel assemblies arranged into at least three regions within the core. The method includes adjusting the coolant flow through the fuel assemblies in a particular region to be the same, and adjusting the coolant flow through the fuel assemblies so that the flow through the fuel assemblies in each region is different from the coolant flow through the fuel assemblies in each other region.

### BRIEF DESCRIPTION OF DRAWINGS

FIG. 1 is a sectional view, with parts cut away, of a boiling water nuclear reactor pressure vessel.

FIG. 2 is a schematic top view of a quadrant of the reactor pressure vessel shown in FIG. 1.

FIG. 3 is a schematic sectional view of the reactor core shown in FIG. 1.

FIG. 4 is a graphical representation of the core flow in accordance with an embodiment of the present invention.

FIG. 5 is a graphical representation of the core flow in a known reactor.

### DETAILED DESCRIPTION

A method of optimizing the reactor core coolant flow distributions is described below in more detail. The flow distribution is modified to match the power distribution in the core which increases the efficiency of the stream separation system and the overall efficiency of the BWR plant. The method optimizes both the exit quality of the core coolant and the fuel moderation in the core.

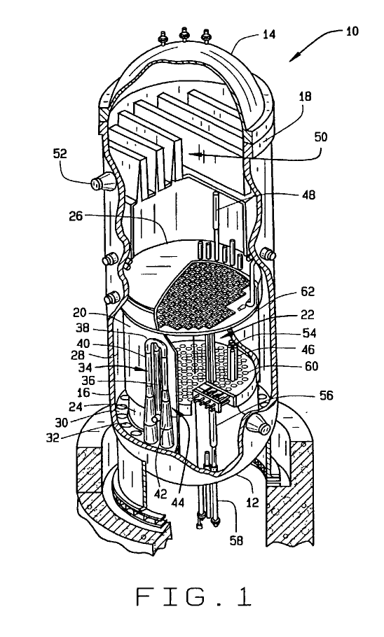

Referring to the drawings, FIG. 1 is a sectional view, with parts cut away, of a boiling water nuclear reactor pressure vessel (RPV) 10. RPV 10 has a generally cylindrical shape and is closed at one end by a bottom head 12 and at its other end by a removable top head 14. A side wall 16 extends from bottom head 12 to top head 14. Side wall 16 includes a top flange 18. Top head 14 is attached to top flange 18. A cylindrically shaped core shroud 20 surrounds a reactor core 22. Shroud 20 is supported at one end by a shroud support 24 and includes a removable shroud head 26 at the other end. An annulus 28 is formed between shroud 20 and side wall 16. A pump deck 30, which has a ring shape, extends between shroud support 24 and RPV side wall 16. Pump deck 30 includes a plurality of circular openings 32, with each opening housing a jet pump 34. Jet pumps 34 are circumferentially distributed around core shroud 20. An inlet riser pipe 36 is coupled to two jet pumps 34 by a transition assembly 38. Each jet pump 34 includes an inlet mixer 40 and a diffuser 42. Inlet riser 36 and two connected jet pumps 34 form a jet pump assembly 44.

Thermal power is generated within core 22, which includes fuel bundles 46 of fissionable material. Water circulated up through core 22 is at least partially converted to steam. Steam separators 48 separates steam from water, which is recirculated. Residual water is removed from the steam by steam dryers 50. The steam exits RPV 10 through a steam outlet 52 near vessel top head 14.

The amount of thermal power generated in core 22 is regulated by inserting and withdrawing control rods 54 of neutron absorbing material, such as for example, boron carbide. To the extent that control rod 54 is inserted into core 22 between fuel bundles 46, it absorbs neutrons that would otherwise be available to promote the chain reaction which generates thermal power in core 22. Control rod guide tubes 56 maintain the vertical motion of control rods 54 during insertion and withdrawal. Control rod drives 58 effect the insertion and withdrawal of control rods 54. Control rod drives 58 extend through bottom head 12.

Fuel bundles 46 are aligned by a core plate 60 located at the base of core 22. A top guide 62 aligns fuel bundles 46 as they are lowered into core 22. Core plate 60 and top guide 62 are supported by core shroud 20.

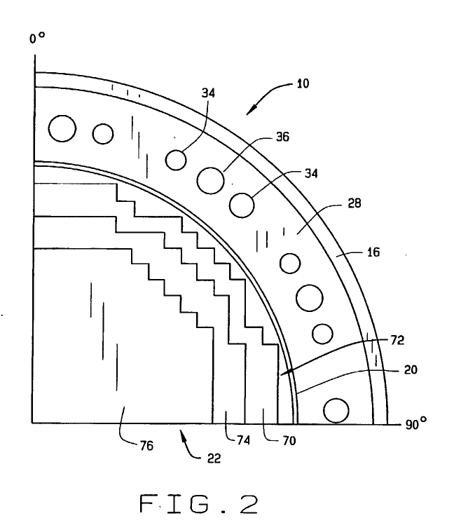

FIG. 2 is a schematic top view of a quadrant of RPV 10 from RPV azimuth 0° to RPV azimuth 90° showing core 22, core shroud 20, and RPV side wall 16. Also shown is annulus 28 located between shroud 20 and RPV side wall 16. Jet pumps 34 and inlet riser pipes 36 are located in annulus 28. Core 22 is divided into three regions, an edge region 70 located circumferentially around an outer edge 72 of core 22, a middle region 74 located adjacent edge region 70, and a central region 76 located in the center of core 22. Middle region 74 is located between edge region 70 and central region 76. The power output of fuel bundles 46 that are located in each of the regions of core 22 are different. Particularly, Edge region 70 contains fuel bundles 46 that produce the lowest power. Fuel bundles 46 that are located in middle region 74 produce higher power than fuel bundles 46 that are located in edge region 70, and fuel bundles 46 located in central region 76 produce higher power than fuel bundles 46 located in middle region 74.

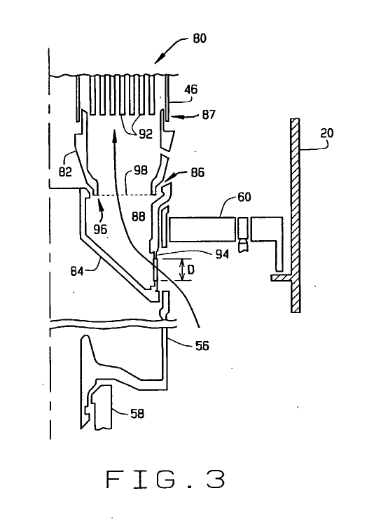

FIG. 3 is a schematic sectional view of reactor core 22 in accordance with an embodiment of the present invention. Reactor core 22, in an exemplary embodiment, includes a fuel assembly 80 that includes a fuel bundle 46, a lower tie plate 82, and a fuel support 84 which is supported by core plate 60 and control rod guide tube 56. A first end 86 (bottom) of lower tie plate 82 couples to fuel support 84 and a second end 87 (top) of lower tie plate 82 is sized and shaped to receive and support fuel bundle 46. A main coolant flow channel 88 extends from a coolant inlet 90 of fuel support 84 through fuel support 84 and lower tie plate 82 to fuel bundle 46 and permits coolant to flow up through fuel bundle 46 around fuel rods 92 contained inside fuel bundle 46. A coolant orifice 94 is located in inlet 90 of fuel support 84. The size of a diameter D of orifice 94 controls the coolant flow through main coolant channel 88 into fuel bundle 46. Orifice 94 is sized so that the coolant flow through each fuel bundle 46 located in a region of core 22 is about the same. Particularly, diameter D of orifice 94 of fuel assemblies 80 located in edge region 70 (shown in FIG. 2) are about the same which results in about the same coolant flow through each fuel assembly 80 located in edge region 70. Diameter D of orifice 94 of fuel assemblies 80 located in middle region 74 are about the same, but are different from diameter D of orifice 94 of fuel assemblies located in edge region 70 and diameter D of orifice 94 of fuel assemblies located in central region 76. Also, diameter D of orifice 94 of fuel assemblies located in central region 76 are about the same, but different from diameter D of orifice 94 of fuel assemblies located in edge region 70 and diameter D of orifice 94 of fuel assemblies located in middle region 74. As a result of the different diameter orifices 94 in each of the regions of core 22, the coolant flow is different in each of the regions of core 22.

A flow restricting device 96 is detachably coupled to first end 86 of lower tie plate 82. A plurality of openings 98 extend through flow restricting device 96. The size and number of openings 98 controls the flow of coolant through main coolant channel 88 into fuel bundle 46. The flow restricting device 96 is sized so that the coolant flow through each fuel bundle 46 located in a region of core 22 is about the same. Particularly, the size and number of openings 98 in flow restricting devices 96 of fuel assemblies 80 located in edge region 70 (shown in FIG. 2) is about the same which results in about the same coolant flow through each fuel assembly 80 located in edge region 70. The size and number of openings 98 in flow restricting device 96 of fuel assemblies 80 located in middle region 74 is the same within the region but is different from the size and number of openings 98 in flow restricting device 96 of fuel assemblies located in edge region 70 and the size and number of openings 98 in flow restricting device 96 of fuel assemblies 80 located in central region 76. Also, the size and number of openings 98 in flow restricting device 96 of fuel assemblies located in central region 76 is the same within the region but different from the size and number of openings 98 in flow restricting device 96 of fuel assemblies 80 located in edge region 70 and the size and number of openings 98 in flow restricting device 96 of fuel assemblies 80 located in middle region 74. As a result of the size and number of openings 98 in flow restricting device 96 in each of the regions of core 22, the coolant flow is different in each of the regions of core 22. The exemplary embodiment shown in FIG. 3 includes both coolant orifice 94 and flow restricting device 96 in fuel assemblies 80. It should be understood that in other embodiments coolant flow can be regulated by coolant orifices 94 without the use of flow restricting devices 96, or the coolant flow can be regulated by flow restricting devices 96 without the use of coolant orifices 94, or the coolant flow can be regulated with coolant orifices 94 in some fuel assemblies 80 and flow restricting devices 96 in other fuel assemblies 80.

In alternate embodiments, reactor core 22 is divided into more than three regions with each region having fuel assemblies with different power output, and the coolant flow through the fuel assemblies is adjusted based on the power output of the fuel assemblies in the regions. The higher the power output of the fuel assemblies in a region, the higher the coolant flow through that region.

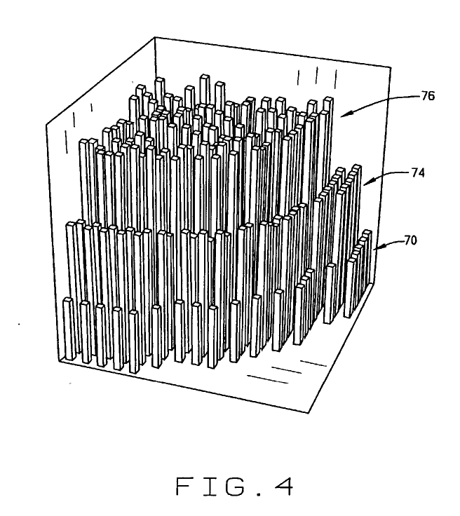

FIG. 4 is a graphical representation of the coolant flow through core 22. The coolant flow is adjusted in each region of core 22 based on the power output of fuel bundles 46 located in each region. Specifically, the coolant flow through fuel assemblies 80 located in edge region 70, the lowest power region of core 22, is lower than the coolant flow through fuel assemblies 80 located in middle region 74, the next highest power region of core 22. Also, the coolant flow through fuel assemblies 80 located in middle region 74 is lower than the coolant flow through fuel assemblies 80 located in central region 76, the highest power region of core 22.

By adjusting the coolant flow through the regions of core 22 as described above, the performance of the steam separation system of the reactor is improved and the nuclear moderation characteristics of the BWR is inhanced and higher neutron efficiency is achieved.

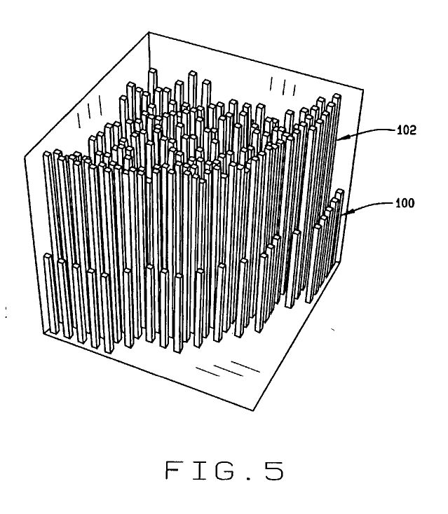

FIG. 5 is a graphical representation of the coolant flow through a known reactor that includes a peripheral orifice region 100 and a center orifice region 102. Peripheral region 100 includes all fuel locations around the periphery of the reactor core, and center region 102 includes the remainder of the fuel locations. The inlet orifice design limits the flow per fuel element in peripheral region 100 to about half of the flow per fuel element center region 102. Having a peripheral flow of this magnitude causes the very low power peripheral fuel elements to produce only small amounts of steam. Therefore, the exit quality and average voids of the coolant from peripheral region 100 are much lower than for center region 102. This uneven exit quality and average void can produce poor steam separation and inefficient nuclear moderation.

While the invention has been described in terms of various specific embodiments, those skilled in the art will recognize that the invention can be practiced with modification within the spirit and scope of the claims.

1. A nuclear reactor core comprising:
a plurality of fuel assemblies, each said fuel assembly comprising a lower tie plate and a main coolant flow channel comprising an inlet;
said plurality of fuel assemblies arranged into at least three regions within said core;
said flow channels configured so that the flow of coolant through said main coolant flow channels of said fuel assemblies located in a particular region are substantially the same, and that the coolant flow through said fuel assemblies in each said region is different from the coolant flow through said fuel assemblies in each other region.

2. A reactor core in accordance with claim 1 further comprising a plurality of coolant orifices, each said coolant orifice located in an inlet of a cooling flow channel.

3. A reactor core in accordance with claim 2 wherein said coolant orifices of said fuel assemblies located in a particular region are sized so that so that the flow of coolant through said main coolant flow channels of said fuel assemblies located in a particular region are substantially the same.

4. A reactor core in accordance with claim 3 wherein said coolant orifices of said fuel assemblies are sized so that the coolant flow through said fuel assemblies in each said region is different from the coolant flow through said fuel assemblies in each other region.

5. A reactor core in accordance with claim 1 wherein said core comprises a substantially circular cross section, and said fuel assemblies are arranged in an edge region located circumferentially around an outer edge of said core, a middle region located adjacent said edge region, and a central region located in the center of said core, said middle region located between said edge region and said central region.

6. A reactor core in accordance with claim 5 wherein the flow of coolant through said fuel assemblies located in said edge region is less than the flow of coolant through said fuel assemblies located in said middle region.

7. A reactor core in accordance with claim 6 wherein the flow of coolant through said fuel assemblies located in said middle region is less than the flow of coolant through said fuel assemblies located in said central region.

8. A reactor core in accordance with claim 1 further comprising a plurality of flow restriction devices, each said flow restriction device detachably coupled to a lower end of said lower tie plate.

9. A reactor core in accordance with claim 8 wherein said flow restriction devices of said fuel assemblies located in a particular region are sized so that so that the flow of coolant through said main coolant flow channels of said fuel assemblies located in a particular region are substantially the same.

10. A reactor core in accordance with claim 9 wherein said flow restriction devices of said fuel assemblies are sized so that the coolant flow through said fuel assemblies in each said region is different from the coolant flow through said fuel assemblies in each other region.

11. A reactor core in accordance with claim 2 further comprising a plurality of flow restriction devices, each said flow restriction device detachably coupled to a lower end of said lower tie plate, said flow restriction devices of said fuel assemblies located in a particular region are sized so that so that the flow of coolant through said main coolant flow channels of said fuel assemblies located in a particular region are substantially the same.

12. A reactor core in accordance with claim 11 wherein said flow restriction devices of said fuel assemblies are sized so that the coolant flow through said fuel assemblies in each said region is different from the coolant flow through said fuel assemblies in each other region.

13. A nuclear reactor core comprising:
a plurality of fuel assemblies, each said fuel assembly comprising a lower tie plate and a main coolant flow channel comprising an inlet; and
a plurality of coolant orifices, each said coolant orifice located in an inlet of a cooling flow channel;
said plurality of fuel assemblies arranged into at least three regions within said core;
said coolant orifices sized so that the flow of coolant through said main coolant flow channels of said fuel assemblies located in a particular region are substantially the same, and that the coolant flow through said fuel assemblies in each said region is different from the coolant flow through said fuel assemblies in each other region.

14. A reactor core in accordance with claim 13 wherein said core comprises a substantially circular cross section, and said fuel assemblies are arranged in an edge region located circumferentially around an outer edge of said core, a middle region located adjacent said edge region, and a central region located in the center of said core, said middle region located between said edge region and said central region.

15. A reactor core in accordance with claim 14 wherein said coolant orifices are sized so the flow of coolant through said fuel assemblies located in said edge region is less than the flow of coolant through said fuel assemblies located in said middle region.

16. A reactor core in accordance with claim 15 wherein said coolant orifices are sized so that the flow of coolant through said fuel assemblies located in said middle region is less than the flow of coolant through said fuel assemblies located in said central region.

17. A reactor core in accordance with claim 13 further comprising a plurality of flow restriction devices, each said flow restriction device detachably coupled to a lower end of said lower tie plate, said flow restriction devices of said fuel assemblies located in a particular region are sized so that so that the flow of coolant through said main coolant flow channels of said fuel assemblies located in a particular region are substantially the same.

18. A nuclear reactor core comprising:
a plurality of fuel assemblies, each said fuel assembly comprising a lower tie plate and a main coolant flow channel comprising an inlet; and
at least one of a plurality of coolant orifices and a plurality of flow restriction devices, each said coolant orifice comprising a diameter and located in an inlet of a cooling flow channel, each said restriction device detachably coupled to a lower end of said lower tie plate;
said plurality of fuel assemblies arranged into at least three regions within said core;
said diameter of said coolant orifices located in a particular region are substantially the same, and said diameter of said coolant orifices of each said region is different from said diameter of said coolant orifices in each other region;
said flow restriction devices located in a particular region are sized to be the same, and the size of said flow restriction devices of each said region is different from the size of said flow restriction devices of each other region.

19. A reactor core in accordance with claim 18 wherein said core comprises a substantially circular cross section, and said fuel assemblies are arranged in an edge region located circumferentially around an outer edge of said core, a middle region located adjacent said edge region, and a central region located in the center of said core, said middle region located between said edge region and said central region.

20. A reactor core in accordance with claim 19 wherein said diameter of said coolant orifices located in said edge region is less than said diameter of said coolant orifices located in said middle region.

21. A reactor core in accordance with claim 20 wherein said diameter of said coolant orifices located in said middle region is less than said diameter of said coolant orifices located in said central region.

22. A reactor core in accordance with claim 21 wherein said flow restriction devices of said fuel assemblies located in a particular region are sized so that the flow of coolant through said main coolant flow channels of said fuel assemblies located in a particular region are substantially the same.

23. A method for optimizing reactor core coolant flow distributions, the reactor core comprising a plurality of fuel assemblies arranged into at least three regions within the core, said method comprising:
adjusting the coolant flow through the fuel assemblies in a particular region to be the same; and
adjusting the coolant flow through the fuel assemblies so that the flow through the fuel assemblies in each region is different from the coolant flow through the fuel assemblies in each other region.

24. A method in accordance with claim 23 wherein each fuel assembly comprises a lower tie plate and a main coolant flow channel comprising an inlet and at least one of an orifice located in the inlet and a flow restriction device detachably coupled to a lower end of said lower tie plate, and adjusting the coolant flow through the fuel assemblies in a particular region to be the same comprises at least one of sizing the diameter of the orifices in each fuel assembly located in a particular region to be the same, and sizing the flow restriction devices in each fuel assembly located in a particular region to be the same.

25. A method in accordance with claim 24 wherein adjusting the coolant flow through the fuel assemblies so that the flow through the fuel assemblies in each region is different from the coolant flow through the fuel assemblies in each other region comprises at least one of sizing the diameter of the orifices of each region to be different than the diameter of the orifices in each other region, and sizing the flow restriction devices in each fuel assembly located in a particular region to be different than the size of the flow restriction devices in each other region.

26. A method in accordance with claim 23 wherein the core comprises a substantially circular cross section, and the fuel assemblies are arranged in an edge region located circumferentially around an outer edge of the core, a middle region located adjacent the edge region, and a central region located in the center of the core, the middle region located between the edge region and the central region.

27. A method in accordance with claim 26 wherein adjusting the coolant flow through the fuel assemblies so that the flow through the fuel assemblies in each region is different from the coolant flow through the fuel assemblies in each other region comprises:
adjusting the flow of coolant through the fuel assemblies located in the edge region to be less than the flow of coolant through the fuel assemblies located in the middle region; and
adjusting the flow of coolant through the fuel assemblies located in the middle region to be less than the flow of coolant through the fuel assemblies located in the central region.
